(19) United States
(12) Patent Application Publication
(10) Pub. No.: US 2001/0022119 A1
(43) Pub. Date: Sep. 20, 2001

(54) UNIVERSAL CAVITY PIT WRENCH

(75) Inventor: TENG-TANG KUO, KEELUNG CITY (TW)

Correspondence Address: BACON & THOMAS, 625 SLATERS LANE, 4TH FLOOR, ALEXANDRIA, VA, 22314

(73) Assignee: TENG-TANG KUO

(21) Appl. No.: 09/473,696

(22) Filed: Dec. 29, 1999

(51) Int. Cl. B25B 13/58

(52) U.S. Cl. 81/185

(57) ABSTRACT

Structural Design of Universal Cavity Pit Wrench, comprising: a sleeving, a mounting panel, a plurality of pillar posts, retainer rods and a plurality of correspondingly functioning retraction springs, for assembling, the plurality of retainer rods are applied to penetrate the mounting panel, get coupled to the retraction spring, then engaged with pillar posts so that the pillar posts are invested with the capability for free retractions, to follow that, the mounting panel is planted into the inner wall of the hollow-set sleeving so that the plurality of pillar posts are neatly deployed on top of the sleeving, so that any nut to be set into the cavity pit, of any type or configuration, may be brought into the cavity pit by the action of those neatly deployed pillar posts, and once all the pillar posts are planted in full into the nut bearing cavity pit loosening or tightening up of an object nut may be proceeded with ease and convenience.

### BACKGROUND OF THE INVENTION

(a) Field of the Invention

Structural design of a universal cavity pit wrench, more specifically that of a wrench or spanner capable of loosening or tightening up screwnuts or operations involving such loosening or tightening effects without directional restrictions executed against nut bearing cavities of any configurations mounted with a plurality of freely retractable pillar posts.

(b) Description of the Prior Art

Conventional art of cavity pit wrenches is typically represented by those which are adapted specifically to work on hexagonal cavity pit nuts, by the dimension of each hexagonal cavity pit nut concerned a hexagonal pillar spanner of a corresponding dimension is chosen to match to loosen or tighten up an object nut, and that necessarily binds the user to bring with him a lot of pillar wrenches of different sizes to meet the demand for working with cavity pit nuts of differing sizes, a common practice among the manufacturers is to assemble the pillar spanners in a set for portable handling, but that execution is still not convenient enough, size insufficiency can still be a problem all the same, improvement is still being sought after; while on the other hand, where the nut set in the cavity pit bears a profile other than hexagonal, petal or polygonal, for example, then the conventional hexagonal pillar spanner can do nothing at all, and the user will have to get at hand specifically configured cavity pit spanner to go ahead with his nut loosening or tightening up operations, so in short, in the prior art, where a different, unforeseen pattern of cavity pit nut or one bearing a different size is encountered, a correspondingly shaped cavity pit spanner will have to be prepared in order to get the job done, and that necessarily brings about increased need for more supply of more varieties of spanner tools, giving occasion to more chances of confusion and shortage of tool is still inevitable from cases to cases.

In U.S. Pat. Nos. 5,644,959, 5,386,749, and 5,460,064, and else, while they provide altogether various multi-purpose wrench designs, they apply uniquely and only to protrusive type nuts, none of them caters to cavity pit type nuts at all.

### SUMMARY OF THE INVENTION

The primary object of the invention, therefore, is to provide structural design of a universal cavity pit type wrench or spanner, comprising essentially: a sleeving, a mounting panel, a plurality of pillar posts, retainer rods and a number of correspondingly functioning retraction springs, with the plurality of pillar posts being aligned and mounted on top of the sleeving, they, so arranged and endowed with retractable effects, stemmed against the nut bearing cavity pits, are able to drive the nuts as set in the cavity pits to loosen off or contrarily to tighten up, and that means then that one single stereotyped universal spanner will suffice to work on a cavity set nut of one out of quite a number of cavity configuration or sizes, in all conveniences relieving the user of the nuisance to switching to another tool while working on different specifications of cavity set nuts.

A further object of the invention lies in the provision of the structural design of a universal cavity pit spanner whereof said plurality of pillar posts are preferably processed to be polygonal or to yield a thinner diameter, so that once inserted by retraction into the nut bearing pit a firm, tight-set plunging effect is assured, whereby yet simpler and more reliable application of force with respect to the nut at work is readily achievable.

### BRIEF DESCRIPTION OF THE DRAWINGS

FIG. 1 is a three-dimensional view of the invention accomplished of realization;

FIG. 2 is an exploded perspective of the invention in a three-dimensional setting;

FIG. 3 is a cross-section view of the invention;

FIG. 4 is a cross-section view of the invention in the process of execution of loosening or tightening up of an object nut set in a working cavity pit according to the invention;

FIG. 5 is a top view of a conventional hexagonal cavity set nut;

FIG. 6 is a top view of a conventional petal pattern cavity set nut; and

FIG. 7 is a top view of a conventional polygonal cavity set nut.

### DETAILED DESCRIPTION OF THE PREFERRED EMBODIMENTS

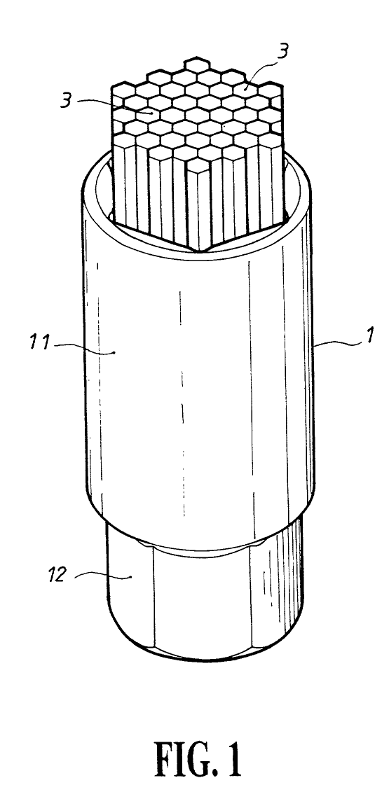

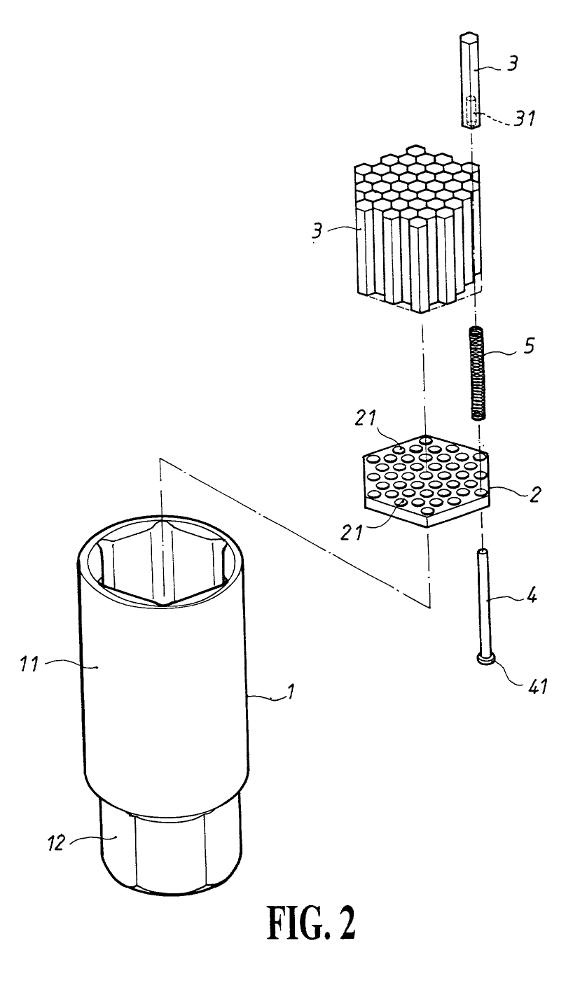

As shown in FIG. 1 and FIG. 2, the invention structure of a universal cavity pit wrench comprises essentially: a sleeving 1, a mounting panel 2, a plurality of pillar posts 3, retainer rod 4 and a number of correspondingly functioning retraction spring 5, whereof:

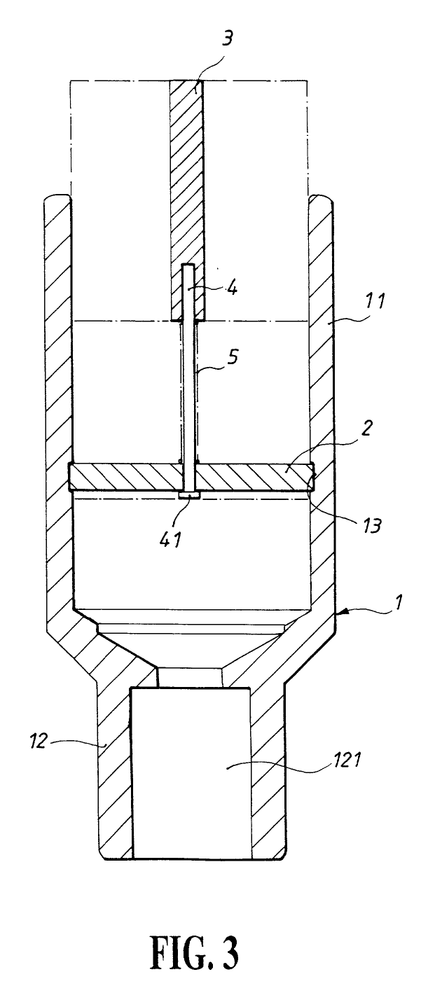

The sleeving 1, executed to be of a hollow-set body and having an angular shoe 11, hexagonal, for example, for coupling with a grip (not shown in the illustration) on its end edge, the angular shoe 12 further incorporating a square groove 121 to accommodate engagement with the grip, the sleeving 1 largely of a conventional structure but then differing in that an annular groove 13, such as what is shown in FIG. 3, is present on the inner wall of the said hollow-set body 11 to accommodate assemblage of the mounting panel 2 which;

Is executed to be a sheet profiled to match said annular groove 13 on the inner wall of said sleeving 1, and once so matched, the engagement is made, on the surface of the mounting panel 2 are evenly and densely distributed a plurality of penetration holes 21;

The plurality of pillar posts 3 is executed to be strap plunger stems each having an access hole provided in the tail edge 31;

The plurality of retainer rods 4 is executed to be a thin rod of suitable length, incorporating a protrusion 41 on the end edge, penetration hole 21 piercing the mounting panel 2 from down side up, and which hole 21 just fits for coupling with retraction spring 5 on projection way off the mounting panel 2;

Said a number of retraction spring 5, mounted about said retainer rods 4 one by one, to bring retainer rods 4 inserted altogether into the insertion holes 31 on the end edge of correspondent pillar posts 3 so as to form a compact coupling, such a coupling may instead be executed in the form of common differential compacting union by setting the bore of the insertion hole 31 slightly smaller than the diameter of the insertion end of the retainer rod 4, or else of glue application, or still of helically applied locking seal;

For assemblage, said plurality of pillar posts 3, retainer rods 4 and retraction springs 5 are firstly mounted one by one symmetrically onto the mounting panel 2, next, the mounting panel 2 is buried by engaging onto the inner annular groove 13 of the sleeving 1, being thrusted by the retraction spring 5, the respective pillar posts 3 are normally neatly projected onto the edge top of the sleeving 1, so that they may project into the nut 6 bearing cavity pit 61, like what is shown in FIG. 4, regardless of the specific pattern or configuration of the nut which fits in said cavity pit, with the pillar posts 3 having been established in the cavity pit 61 serving to facilitate loosening or tightening up of the nut 6 once they, the pillar posts 3, are established full in position.

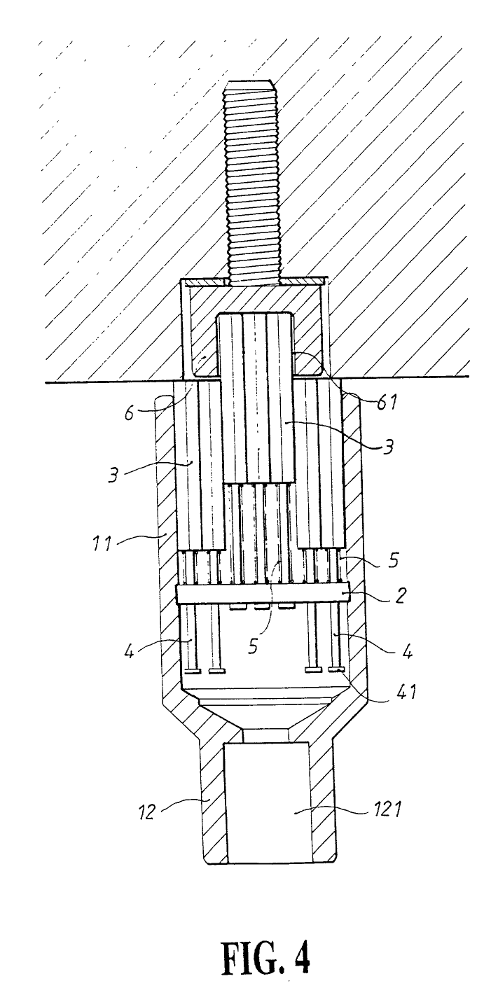

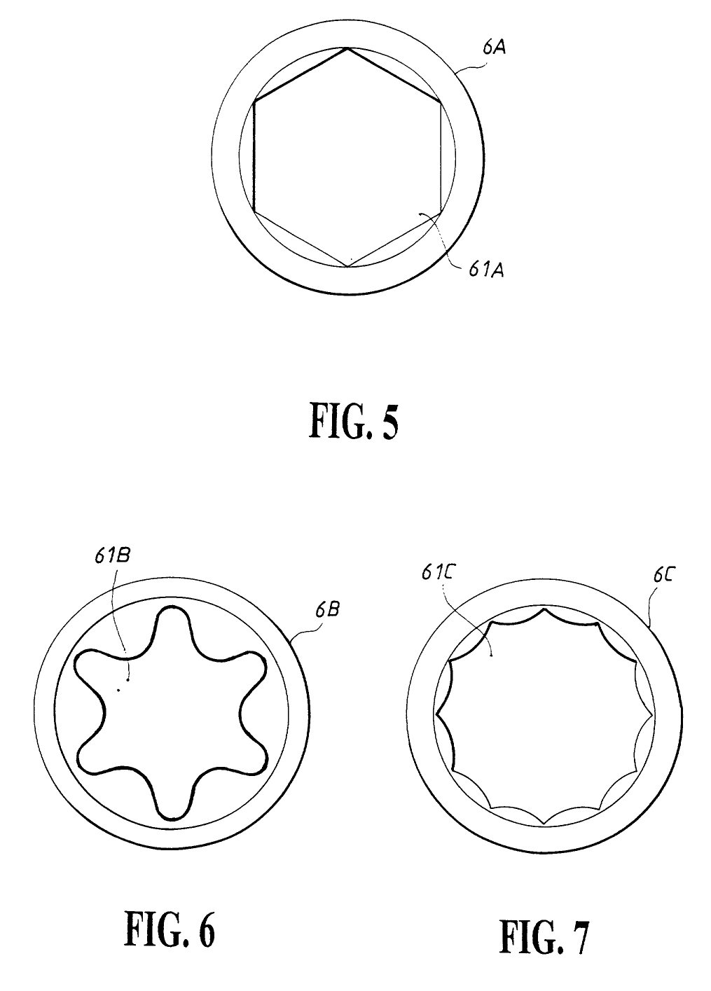

By the design of the invention Universal Cavity Pit Wrench, by means of the plurality of pillar posts 3 movably mounted upon the nut bearing cavity pits 61A, 61B or 61C as provided therewith, nuts of various conceivable pattern or design, hexagonal 6A, petal 6B, or polygonal 6C, and what not, such as those illustrated in FIG. 5 through FIG. 7, may readily be driven to a loosened state or on the contrary, to a tightened up state, as desired, so in short, with a single, simply stereotyped universal cavity put wrench, structured according to the invention, it is made possible to work, for all purposes for which a wrench or spanner is meant to serve, with and on a nut bearing cavity pit of any conceivable or existent pattern or design which is the seat for a correspondently shaped nut whatsoever, in all conveniences without much ado.

Moreover, as a characteristic feature of the invention, the plurality of pillar posts 3 to be employed are preferably those treated polygonal or such that their diameters are rendered thinner, for effort as such will assure better interactive detention, on the one hand, and of more consistent, compact alignment when set in the nut bearing cavity pit, on the other hand, facilitating easier application of force at operation.

1. Structural design of Universal Cavity Pit Wrench, comprising: a sleeving, a mounting panel, a plurality of pillar posts, retainer rod and a number of correspondingly functioning retraction springs, characterised in that:
The sleeving, hollow-set, has its edge end processed to accommodate coupling with a grip, and has an annular groove built on the inner wall of the hollow-set body;
The mounting panel, executed to be a sheet profiled to match said annular groove on the inner wall of said sleeving, and once so matched, the engagement is made, on the surface of the mounting panel are evenly and densely distributed a plurality of penetration holes;
The plurality of pillar posts is executed to be strap plunger stems each having an access hole provided on the tail edge;
The plurality of retainer rods 4 is executed to be a thin rod of suitable length, incorporating a protrusion on the end edge, penetration hole piercing the mounting panel from down side up, and which hole just fits for coupling with retraction spring on projection way off the mounting panel;
The plurality of retraction spring is mounted about said retainer rods one by one, to bring retainer rods inserted altogether into the insertion holes on the end edge of correspondent pillar posts so as to form a compact coupling;
Once assembled and each part secured in position, the respective pillar posts, being thrusted by the retraction spring, are normally neatly projected onto the edge top of the sleeving, so that they may project into the nut bearing cavity pit, regardless of the particular pattern or configuration of the nut which fits in said cavity pit, with the pillar posts having been established in the cavity pit serving to facilitate loosening or tightening up of the nut once they, the pillar posts, are established full in position.

2. Universal Cavity Pit Wrench according to claim 1, whereof coupling between the retainer rods and pillar posts is made by way of common differential compaction bonding, glue application or helically applied locking efforts.

3. Universal Cavity Pit Wrench according to claim 1, whereof said plurality of pillar posts are preferably executed in the form of polygonal configuration, or such that the diameter of each post is made as thin as possible.
